(19) United States
(12) Patent Application Publication
(10) Pub. No.: US 2020/0311797 A1
(43) Pub. Date: Oct. 1, 2020

(54) INFORMATION PROCESSING APPARATUS AND INFORMATION PROCESSING METHOD

(71) Applicant: TOSHIBA TEC KABUSHIKI KAISHA, Tokyo (JP)

(72) Inventor: Masato Oishi, Numazu Shizuoka (JP)

(21) Appl. No.: 16/687,138

(22) Filed: Nov. 18, 2019

(30) Foreign Application Priority Data
Mar. 26, 2019 (JP) 2019-059201

(51) Int. Cl. G06Q 30/06

(52) U.S. Cl. CPC G06Q 30/0631; G06Q 30/0641

(57) ABSTRACT

In one embodiment, an information processing apparatus has a storage device and a controller. The controller acquires information for determining a recommended commodity to be recommended to a customer from the storage device, as recommendation information, based on information of a sales time, information of a sales position, and information of a customer attribute. The controller determines the recommended commodity, based on the acquired recommendation information.

### CROSS-REFERENCE TO RELATED APPLICATION

This application is based upon and claims the benefit of priority from the prior Japanese Patent Application No. 2019-059201, filed on Mar. 26, 2019, the entire contents of which are incorporated herein by reference.

### FIELD

Embodiments described herein relate generally to an information processing apparatus and an information processing method.

### BACKGROUND

Conventionally, transaction methods are known in which a customer accesses a site of electronic commerce using an information terminal of the customer to purchase a commodity from the site. In such a case, when the customer has purchased the commodity, the site of electronic commerce may supply a recommendation of a specific commodity to the information terminal of the customer. For example, the site of electronic commerce may recommend another commodity which is related to the commodity that the customer has just purchased but has been purchased more by other customers, or another commodity having a feature similar to the commodity that the customer has just purchased.

However, there have been cases in which it is not possible to recommend a specific commodity to the customer by the above-described recommendation method.

### BRIEF DESCRIPTION OF THE DRAWINGS

FIG. 1 is a schematic diagram showing an electronic commerce system including a recommend server according to an embodiment.

FIG. 2 is a block diagram showing a hardware configuration of the recommend server according to the embodiment.

FIG. 3 is a diagram showing the data storage section of the storage device according to the embodiment.

FIG. 4 is a diagram showing data samples.

FIG. 5 is a diagram showing a deviation value of the number of sales of commodities by classification and by sales time zone.

FIG. 6 is a diagram showing a deviation value of the number of sales of commodities by classification and by sales area.

FIG. 7 is a diagram showing a deviation value of the number of sales of commodities by classification and by customer attribute.

FIG. 8 is a functional block diagram showing a functional configuration of the recommend server according to the embodiment.

FIG. 9 is a flow chart showing a control processing of the recommend server according to the embodiment.

### DETAILED DESCRIPTION

According to one embodiment, an information processing apparatus manages an electronic commerce site which a customer accesses from an information terminal of the customer (e.g., the customer's own information terminal) to purchase a commodity. The information processing apparatus has a communication interface, a storage device, and a controller. The communication interface communicates with the information terminal to perform transmission/reception of information with the information terminal. The storage device stores sales information of a commodity by sales time zone of the commodity, by sales area of the commodity, and by customer attribute of the commodity, in association with information indicating the commodity. The controller acquires information of a sales time indicating the sales time of the commodity, information of a sales position indicating a position of the information terminal at the relevant sales time, and information of a customer attribute indicating an attribute of the customer, from the information terminal, via the communication network. The controller acquires information for determining a recommended commodity to be recommended to the customer from the storage device, as recommendation information, based on the information of the sales time, the information of the sales position, and the information of the customer attribute which have been acquired. The controller determines the recommended commodity based on the recommendation information. Further, the controller transmits information indicating the determined recommended commodity to the information terminal, via the communication interface.

Hereinafter, embodiments according to the present invention will be described with reference to the drawings. In the drawings, the same symbols indicate the same or the similar portions. In the embodiments, a recommend server will be described as an example of an information processing apparatus. In addition, the embodiments are not limited to this, by the following description.

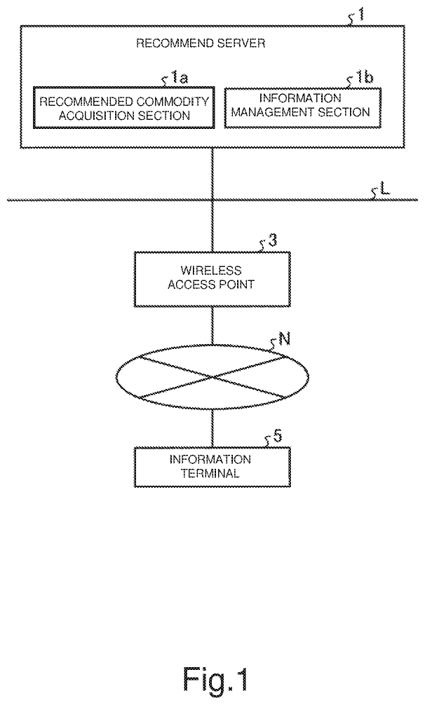

FIG. 1 is a schematic diagram showing an electronic commerce system according to an embodiment. As shown in FIG. 1, the electronic commerce system has a recommend server 1, a wireless access point 3, and an information terminal 5. The recommend server 1 manages an electronic commerce site which a customer accesses from the information terminal of the customer oneself to purchase a commodity. The recommend server 1 connects to the information terminal 5, via the wireless access point 3 and a network N such as Internet, as described later. In addition, in the embodiment, the number of the recommend servers 1 is one. But, when the recommend servers 1 are used in a cloud (system), the number of the recommend servers 1 may be plural.

The recommend server 1 and the wireless access point 3 are connected by a communication line L such as a LAN (Local Area Network). In addition, the wireless access point 3 connects to the recommend server 1 and one or a plurality of the information terminals 5, via the network N.

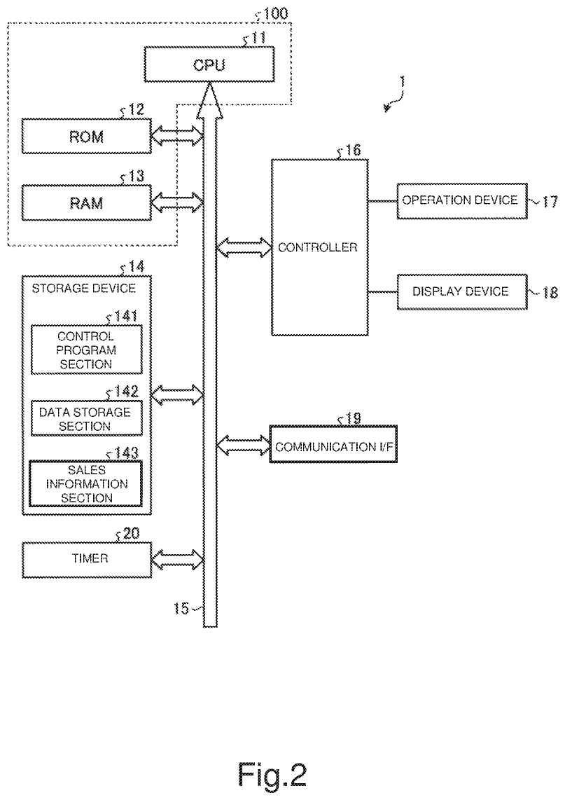

The recommend server 1 has a recommended commodity acquisition section 1a and an information management section 1b. The recommended commodity acquisition section 1a includes a controller 100 (refer to FIG. 2) described later, and so on. The recommended commodity acquisition section 1a acquires information described later from the information terminal 5 which has accessed the recommend server 1. In addition, the recommended commodity acquisition section 1a determines a recommended commodity, based on the information acquired from the information terminal 5. In addition, the recommended commodity acquisition section 1a transmits information of the recommended commodity to the information terminal 5 which has accessed the recommend server 1.

The information management section 1b has a data storage section 142 (a storage section) (refer to FIG. 2) described later. In addition, the information management section 1b stores information of the commodity sold in the electronic commerce system in the data storage section 142 by customer. The recommended commodity acquisition section 1a has the controller 100 (refer to FIG. 2) described later. The recommended commodity acquisition section 1a searches the data storage section 142 of the information management section 1b, and acquires recommendation information described later corresponding to the information acquired from the information terminal 5. Further, the recommended commodity acquisition section 1a may determine a recommended commodity based on the relevant recommendation information, or may comprehensively determine one recommended commodity, using the relevant recommendation information as one option, and including recommendation information collected by another means. For example, the recommended commodity acquisition section 1a comprehensively determines one recommended commodity by adding the above-described recommendation information, to information of a commodity extracted based on purchase history information of a commodity which another person has purchased and browsing history information of another person, and information of a commodity extracted based on the feature of the commodity which the customer has purchased.

The information terminal 5 is a computer connectable to the network N. For example, the information terminal 5 is a smartphone, a portable telephone, a PDA (Personal Digital Assistant), a PC (Personal Computer), or the like.

From here on out, hardware of the recommend server 1 will be described. FIG. 2 is a block diagram showing a hardware configuration of the recommend server 1. The recommend server 1 has a CPU (Central Processing Unit) 11, a ROM (Read Only Memory) 12, a RAM (Random Access Memory) 13, a storage device 14, and so on. The CPU 11 is a control subject. The ROM 12 stores various programs. The RAM 13 develops the various programs and various data. The storage device 14 stores various programs. The CPU 11, the ROM 12, the RAM 13, and the storage device 14 are connected to each other, via a data bus 15. The CPU 11, the ROM 12, and the RAM 13 composes the controller 100. That is, the controller 100 operates in accordance with a control program which is stored in the ROM 12 or the storage device 14 and has been developed in the RAM 13. The controller 100 operates in accordance with the control program to execute a control processing described later of the recommend server 1.

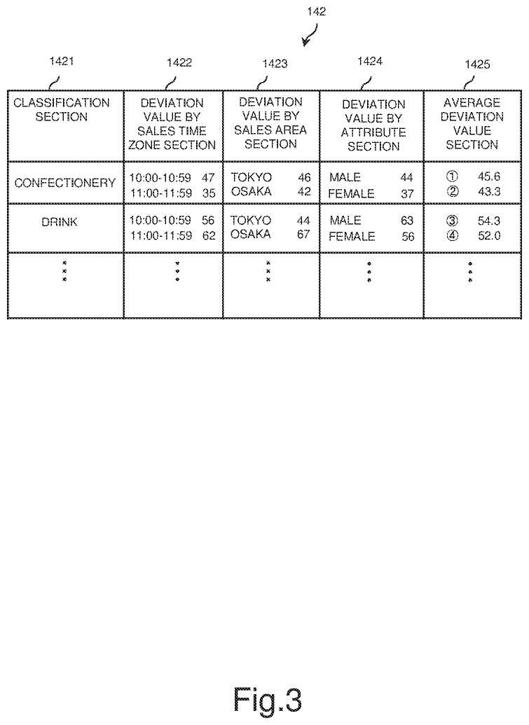

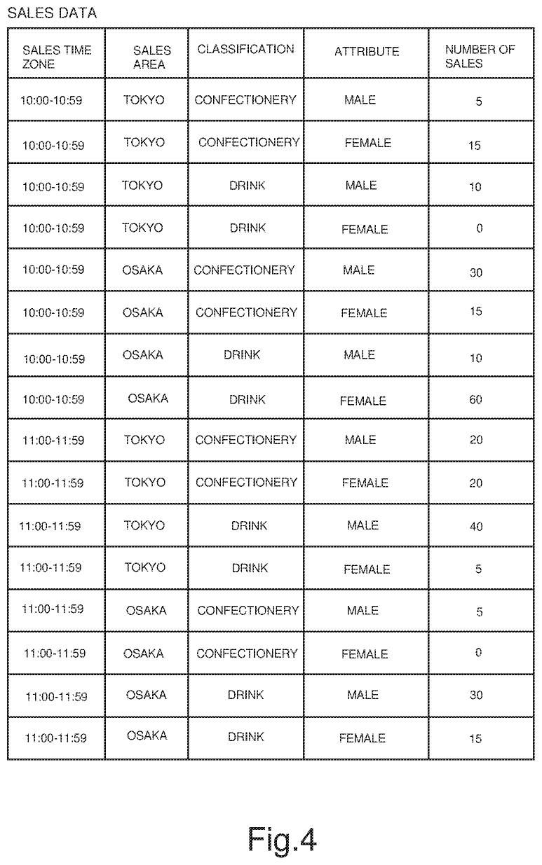

The storage device 14 has a control program section 141, a data storage section 142, and a sales information section 143, as shown in FIG. 2. The control program section 141 stores the program for controlling the recommend server 1. The data storage section 142 stores various information serving as references for determining a recommended commodity. The data storage section 142 will be described later with reference to FIG. 3. The sales information section 143 classifies sales data of the commodities sold in the electronic commerce system by sales time zone or by sales time, by sales area, and by attribute of a customer, and stores the classified sales data (for example, refer to FIG. 4).

In addition, the recommend server 1 has a controller 16, an operation device 17, a display device 18, a communication I/F 19, and a timer 20. The controller 100 connects to the operation device 17 and the display device 18, via the data bus 15 and the controller 16. The operation device 17 is a touch panel type keyboard for operating the recommend server 1. The display device 18 displays information to an operator of the recommend server 1.

In addition, the controller 100 connects to the communication interface (the communication I/F) 19 and the timer 20, via the data bus 15. The communication I/F 19 connects to the information terminal 5, via the communication line L and the network N to perform transmission/reception of the information. The timer 20 counts and outputs a current time.

Subsequently, the data storage section 142 will be described. FIG. 3 is a diagram showing the data storage section 142 of the storage device 14. The data storage section 142 stores various information for determining a recommended commodity to be transmitted to the information terminal 5 connected to the recommend server 1. As shown in FIG. 3, the data storage section 142 has a classification section 1421, a deviation value by sales time zone section 1422, a deviation value by sales area section 1423, a deviation value by attribute section 1424, and an average deviation value section 1425. The classification section 1421 stores a classification of a commodity (information indicating a commodity) which ties commodities by an upper concept of the relevant commodities, such as confectionery, vegetable, meat, drink, and so on, for example. The deviation value by sales time zone section 1422 stores, in association with each classification, a deviation value of the number of sales of commodities by sales time zone (a deviation value by sales time zone) which is calculated by sales time zone (for example, between ten and eleven (10:00-10:59) and between eleven and twelve (11:00-11:59)) including a time when a commodity has been purchased (sold), along with sales time zone information (information indicating a sales time zone), for example. The deviation value is a numerical value representing at what position a certain numerical value is in the group including the relevant numerical value. The deviation value by sales area section 1423 stores, in association with each classification, a deviation value of the number of sales of commodities by sales area (a deviation value by sales area) which is calculated by sales area (for example, Tokyo, Osaka) including a position where a commodity has been purchased, along with sales area information (information indicating a sales area), for example. The deviation value by attribute section 1424 stores, in association with each classification, a deviation value of the number of sales of commodities by customer attribute (a deviation value by attribute) which is calculated by attribute (for example, sex, age) of a person who has purchased a commodity, along with customer attribute information (information indicating a customer attribute), for example. The average deviation value section 1425 stores an average deviation value which is obtained by averaging the deviation value by sales time zone, the deviation value by sales area, and the deviation value by attribute, by classification stored in the classification section 1421.

Here, a calculation method of the deviation value by sales time zone, the deviation value by sales area, and the deviation value by attribute will be described. FIG. 4 is a diagram showing sales data stored in the sales information section 143 of the storage device, for example. That is, the sales information section 143 stores sales data indicating a sales time zone when an individual commodity has been sold, a sales area, a classification of the commodity, an attribute (sex) of persons who has purchased the commodity, and the number of sales of the commodities with the relevant classification. Sales data of the sales information section 143 shown in FIG. 4 indicates that the number of commodities with a classification of confectionery which persons with an attribute of male have purchased in a sales time zone of 10:00 a.m.-10:59 a.m. in Tokyo is 5, for example. Similarly, sales data of the sales information section 143 indicates that the number of commodities with a classification of drink which persons with an attribute of female have purchased in a sales time zone of 10:00 a.m.-10:59 a.m. in Osaka is 60, for example. In addition, the sales data of the sales information section 143 shown in FIG. 4 is an example, and with respect to another sales time zone, another sales area, another classification of commodity, another attribute, sales data is tallied and stored in the sales information section 143.

According to the sales data of the sales information section 143 shown in FIG. 4, regarding the sales time zone, there are two kinds of 10:00-10:59, and 11:00-11:59, the sales areas are Tokyo and Osaka, and regarding the classification of commodity, there are two kinds of confectionery and drink. Accordingly, sales data of the number of sales of commodities by classification and by sales time zone are as follows, for example. The number of sales of commodities with the classification of confectionery in the sales time zone of 10:00-10:59 is 65. The number of sales of commodities with the classification of drink in the sales time zone of 10:00-10:59 is 80. The number of sales of commodities with the classification of confectionery in the sales time zone of 11:00-11:59 is 45. The number of sales of commodities with the classification of drink in the sales time zone of 11:00-11:59 is 90. That is, the number of the sales data of the number of sales of commodities by classification and by sales time zone is 4. And an average value of the number of sales is 70.

The controller 100 calculates a standard deviation of the number of sales of commodities by classification and by sales time zone, based on the above-described sales data. In addition, the standard deviation is a numerical value representing the degree of variation in random variables of data. The smaller the variation is, the smaller the standard deviation becomes. The standard deviation is obtained by a following expression (1). In the expression (1), σ is a standard deviation, n is the number of data, x₁ is the number of sales, x is an average value of the number of sales (an average number of sales). In addition, as described above, the number of data n=4, the average value of the number of sales x=70.

$$σ = \sqrt{\frac{1}{n} {\sum }_{i = 1}^{n} {( {x}_{i} - x )}^{2}} \qquad ( 1 )$$

When the above-described data of the number of sales of commodities by classification and by sales time zone based on the data stored in the sales information section 143 are substituted in the expression (1), the standard deviation σ a of the number of sales of commodities by classification and by sales time zone is obtained by a following expression (2).

$$\begin{matrix}σ a = \sqrt{\frac{1}{4} \{ {( 65 - 70 )}^{2} + {( 80 - 70 )}^{2} + {( 45 - 70 )}^{2} + {( 90 - 70 )}^{2} \}} \\ = \sqrt{287.5} = 16.9 \; 5582\end{matrix} \qquad ( 2 )$$

Similarly, sales data of the number of sales of commodities by classification and by sales area are as follows. The number of sales of commodities with the classification of confectionery in the sales area that is Tokyo is 60. The number of sales of commodities with the classification of drink in the sales area that is Tokyo is 55. The number of sales of commodities with the classification of confectionery in the sales area that is Osaka is 50. The number of sales of commodities with the classification of drink in the sales area that is Osaka is 115. In addition, the number of the sales data of the number of sales of commodities by classification and by sales area is 4. And the average value of the number of sales is 70. The controller 100 calculates a standard deviation σb of the number of sales of commodities by classification and by sales area, based on the above-described sales data. That is, the standard deviation σb of the number of sales of commodities by classification and by sales area is obtained by a following expression (3).

$$\begin{matrix}σ b = \sqrt{\frac{1}{4} \{ {( 60 - 70 )}^{2} + {( 55 - 70 )}^{2} + {( 50 - 70 )}^{2} + {( 115 - 70 )}^{2} \}} \\ = \sqrt{687.5} = 26.2 \; 2022\end{matrix} \qquad ( 3 )$$

Similarly, sales data of the number of sales of commodities by classification and by customer attribute are as follows. The number of sales of commodities with the classification of confectionery by persons with the customer attribute that is male is 60. The number of sales of commodities with the classification of drink by persons with the customer attribute that is male is 90. The number of sales of commodities with the classification of confectionery by persons with the customer attribute that is female is 50. The number of sales of commodities with the classification of drink by persons with the customer attribute that is female is 80. In addition, the number of the sales data of the number of sales of commodities by classification and by customer attribute is 4. And the average value of the number of sales is 70. The controller 100 calculates a standard deviation cc of the number of sales of commodities by classification and by customer attribute, based on the above-described sales data. That is, the standard deviation cc of the number of sales of commodities by classification and by customer attribute is obtained by a following expression (4).

$$\begin{matrix}σ c = \sqrt{\frac{1}{4} \{ {( 60 - 70 )}^{2} + {( 90 - 70 )}^{2} + {( 50 - 70 )}^{2} + {( 80 - 70 )}^{2} \}} \\ = \sqrt{250} = 15.8 \; 1138\end{matrix} \qquad ( 4 )$$

Next, based on the standard deviations obtained as described above, the controller 100 obtains a deviation value of the number of sales of commodities by classification and by sales time zone, a deviation value of the number of sales of commodities by classification and by sales area, and a deviation value of the number of sales of commodities by classification and by customer attribute. The deviation value is obtained by a following expression (5). In the expression (5), Ti is a deviation value, xᵢ is the number of sales, x (=70) is an average value of the number of sales, σ is a standard deviation.

$$Ti = 10 \frac{{x}_{i} - x}{σ} + 50 \qquad ( 5 )$$

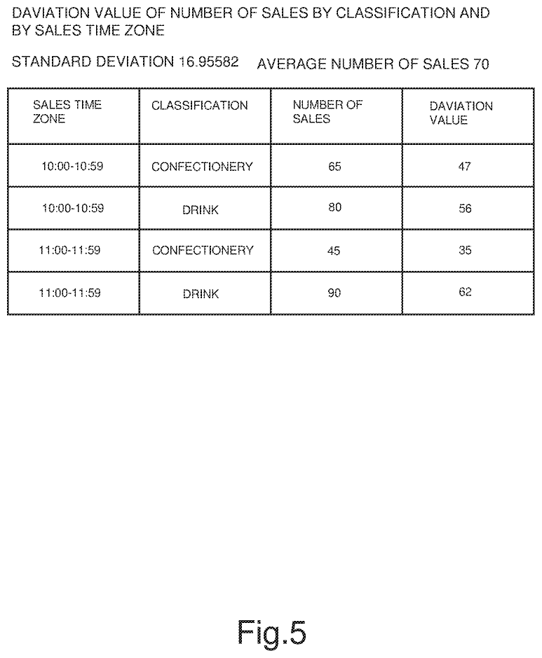

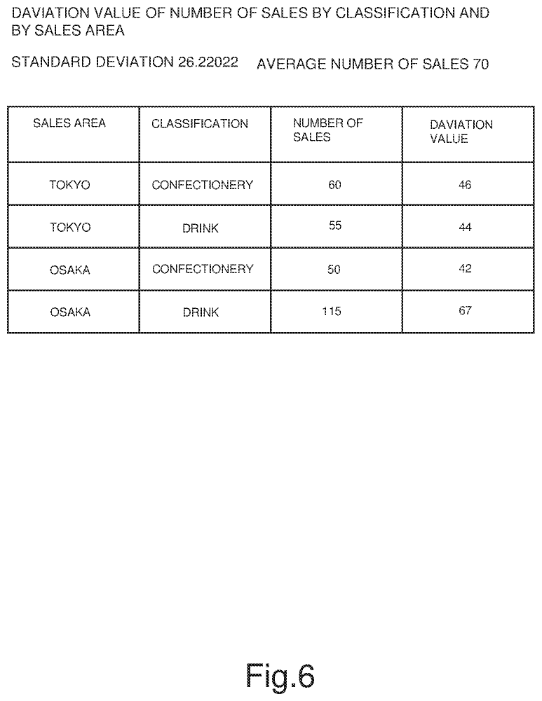

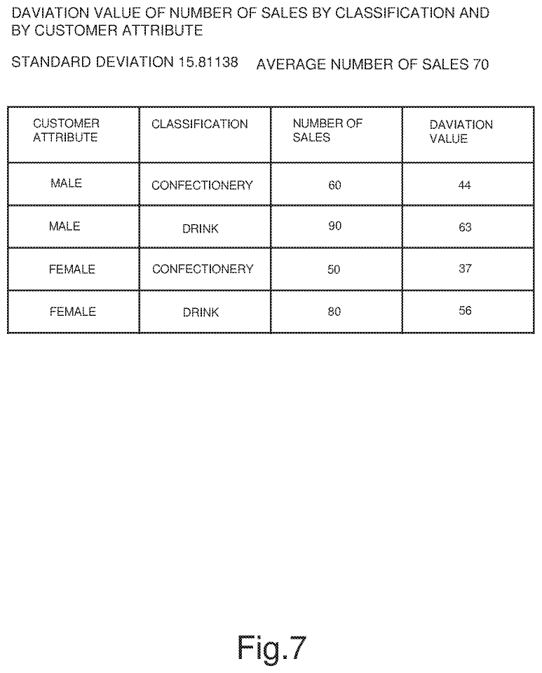

When x₁−x and the obtained standard deviation σ in the above-described expression (2) are substituted in this expression (5), a deviation value of the number of sales of commodities by classification and by sales time zone is obtained as in the following, and is temporarily stored in the RAM 13, for example. FIG. 5 is a diagram showing the deviation value of the number of sales of commodities by classification and by sales time zone which is stored in the RAM 13. That is, as shown in FIG. 5, the deviation value Ti of the classification of confectionery in the sales time zone of 10:00-10:59 is 47. The deviation value Ti of the classification of drink in the sales time zone of 10:00-10:59 is 56. The deviation value Ti of the classification of confectionery in the sales time zone of 11:00-11:59 is 35. The deviation value Ti of the classification of drink in the sales time zone of 11:00-11:59 is 62. In addition, when x₁−x and the obtained standard deviation in the above-described expression (3) are substituted in the above-described expression (5), a deviation value of the number of sales of commodities by classification and by sales area is obtained as in the following, and is temporarily stored in the RAM 13, for example. FIG. 6 is a diagram showing the deviation value of the number of sales of commodities by classification and by sales area which is stored in the RAM 13. That is, as shown in FIG. 6, the deviation value Ti of the classification of confectionery in the sales area of Tokyo is 45. The deviation value Ti of the classification of drink in the sales area of Tokyo is 44. The deviation value Ti of the classification of the confectionery in the sales area of Osaka is 42. The deviation value Ti of the classification of drink in the sales area of Osaka is 67. In addition, when x₁−x and the obtained standard deviation in the above-described expression (4) are substituted in the above-described expression (5), a deviation value of the number of sales of commodities by classification and by customer attribute is obtained as in the following, and is temporarily stored in the RAM 13, for example. FIG. 7 is a diagram showing the deviation value of the number of sales of commodities by classification and by customer attribute which is stored in the RAM 13. That is, as shown in FIG. 7, the deviation value Ti of the classification of confectionery by persons with the customer attribute that is male is 44. The deviation value Ti of the classification of drink by persons with the customer attribute that is male is 63. The deviation value Ti of the classification of confectionery by persons with the customer attribute that is female is 37. The deviation value Ti of the classification of drink by persons with the customer attribute that is female is 56. And the controller 100 organizes the above-described results temporarily stored in the RAM 13 by classification, and stores the organized result in the data storage section 142 of FIG. 3. Specifically, in the data storage section 142, the deviation value 47 of the classification of confectionery in the sales time zone of 10:00-10:59, and the deviation value 35 of the classification of confectionery in the sales time zone of 11:00-11:59 are stored, along with the sales time zone information, in the deviation value by sales time zone section 1422 corresponding to the confectionery, based on the classification, as shown in FIG. 3. In addition, the deviation value 56 in the sales time zone of 10:00-10:59, and the deviation value 62 in the sales time zone of 11:00-11:59 are stored, along with the sales time zone information, in the deviation value by sales time zone section 1422 corresponding to the drink, as shown in FIG. 3. In addition, with respect to the other sales time zones, the deviation values are similarly stored.

In addition, the deviation value 46 of the classification of confectionery corresponding to the sales area of Tokyo, and the deviation value 42 of the classification of confectionery corresponding to the sales area of Osaka are stored, along with the sales area information, in the deviation value by sales area section 1423 corresponding to the confectionery, based on the classification, as shown in FIG. 3. In addition, the deviation value 44 of the classification of drink corresponding to the sales area of Tokyo, and the deviation value 67 of the classification of drink corresponding to the sales area of Osaka are stored, along with the sales area information, in the deviation value by sales area section 1423 corresponding to the drink, as shown in FIG. 3.

In addition, the deviation value 44 of the classification of confectionery corresponding to the customer attribute of male, and the deviation value 37 of the classification of confectionery corresponding to the customer attribute of female are stored, along with the customer attribute information, in the deviation value by attribute section 1424 corresponding to the confectionery, based on the classification, as shown in FIG. 3. In addition, the deviation value 63 of the classification of drink corresponding to the customer attribute of male, and the deviation value 56 of the classification of drink corresponding to the customer attribute of female are stored, along with the customer attribute information, in the deviation value by attribute section 1424 corresponding to the drink, as shown in FIG. 3. In addition, though not shown in FIG. 3, with respect to the classification other than the confectionery and the drink, deviation values calculated in the same manner corresponding to respective classifications are stored in the deviation value sections 1422-1424. In addition, in the data storage section 142, following average deviation values of \textcircled{1}, \textcircled{2}, for example, are stored in the average deviation value section 1425 corresponding to the confectionery, based on the classification.

\textcircled{1} An average deviation value of the confectionery “45.6” (=(47+46+44)/3) that is an average value of the deviation value “47” of the confectionery in the sales time zone of “10:00-10:59”, the deviation value “46” of the confectionery in the sales area of “Tokyo”, and the deviation value “44” of the confectionery by persons with the customer attribute of “male”.
\textcircled{2} An average deviation value of the confectionery “43.3” (=(47+46+37)/3) that is an average value of the deviation value “47” of the confectionery in the sales time zone of “10:00-10:59”, the deviation value “46” of the confectionery in the sales area of “Tokyo”, and the deviation value “37” of the confectionery by persons with the customer attribute of “female”.

In addition, FIG. 3 only shows the above-described average deviation values of \textcircled{1} and \textcircled{2} in the average deviation value section 1425 corresponding to the confectionery, but average deviation values of the confectionery other than the above-described \textcircled{1} and \textcircled{2} which are calculated in the same manner while the combination of the sales time zone, the sales area, and the customer attribute is changed are stored in the average deviation value section 1425. In addition, in the data storage section 142, following average deviation values of 2, & for example, are stored in the average deviation value section 1425 corresponding to the drink, based on the classification.

\textcircled{3} An average deviation value of the drink “54.3” (=(56+44+63)/3) that is an average value of the deviation value “56” of the drink in the sales time zone of “10:00-10:59”, the deviation value “44” of the drink in the sales area of “Tokyo”, and the deviation value “63” of the drink by persons with the customer attribute of “male”.
\textcircled{4} An average deviation value of the drink “52.0” (=(56+44+56)/3) that is an average value of the deviation value “56” of the drink in the sales time zone of “10:00-10:59”, the deviation value “44” of the drink in the sales area of “Tokyo”, and the deviation value “56” of the drink by the customer attribute of “female”.

In addition, FIG. 3 only shows the above-described average deviation values of \textcircled{3} and \textcircled{4} in the average deviation value section 1425 corresponding to the drink, but average deviation values of the drink other than the above-described \textcircled{3} and \textcircled{4} which are calculated in the same manner while the combination of the sales time zone, the sales area, and the customer attribute is changed are stored in the average deviation value section 1425. In addition, though not shown in FIG. 3, with respect to the classification other than the confectionery and the drink, average deviation values corresponding to respective classifications calculated in the same manner are stored in the average deviation value section 1425.

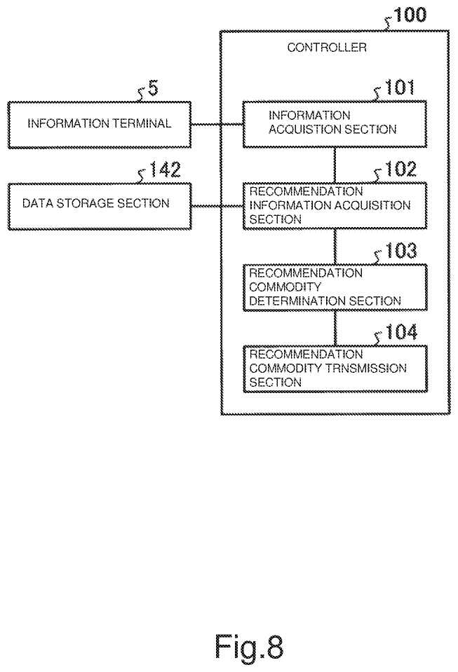

From here on out, a functional configuration of the recommend server 1 will be described. FIG. 8 is a functional block diagram showing a functional configuration of the recommend server 1. As shown in FIG. 8, the controller 100 of the recommend server 1 operates in accordance with the control program which is stored in the ROM 12 or the storage device 14 and has been developed in the RAM 13 to function as an information acquisition section 101, a recommendation information acquisition section 102, a recommended commodity determination section 103, a recommended commodity transmission section 104.

The information acquisition section 101 acquires information from the information terminal 5. The information to be acquired from the information terminal 5 includes sales time information of a commodity, sales position information indicating a position of the above-described information terminal 5 at the relevant sales (purchase) time, and customer attribute information indicating an attribute of the above-described customer. Specifically, when the information terminal 5 has accessed the recommend server 1 and has logged in, the information acquisition section 101 acquires customer attribute information from the relevant information terminal 5. In addition, when the customer has operated the information terminal 5 to purchase a commodity, the information acquisition section 101 acquires a time when the commodity has been purchased as sales time information, and further acquires information of a sales position where the commodity has been purchased (GPS (Global Positioning System) information of the information terminal 5, for example) as sales position information.

The recommendation information acquisition section 102 acquires recommendation information from the data storage section 142 (the storage section), based on the sales time information, the sales position information, and the customer attribute information which the information acquisition section 101 has acquired. In addition, the recommendation information is information for determining a recommended commodity. The recommended commodity is a commodity which the recommend server 1 recommends to the customer who has purchased the commodity as described above, that is, to the customer to whom the recommend server 1 has sold the commodity. The recommended commodity is a commodity of the classification (the confectionery, the drink, or the like in FIG. 3) which satisfies the sales time zone and the sales area when and where the relevant commodity has been sold to the customer, and the customer attribute, for example. The recommendation information acquisition section 102 compares the customer attribute information which the information acquisition section 101 has acquired, sales time zone information in which the sales time information that the information acquisition section 101 has acquired is included, and sales area information in which the sales position information that the information acquisition section 101 has acquired is included, with the customer attribute information, the sales time zone information, and the sales area information which are stored in the data storage section 142, respectively. And the recommendation information acquisition section 102 acquires information of a deviation value (an average deviation value) of a plurality of classifications in each of which all the three informations are respectively coincident, as the recommendation information.

For example, when a male accessed the recommend server 1 at 10:30 from Tokyo has purchased a commodity, the recommendation information acquisition section 102 compares the sales time zone information indicating that the sales time zone is “10:00-10:59”, the sales area information indicating that the sales area is “Tokyo”, and the customer attribute information indicating that the customer attribute is “male”, with the sales time zone information, the sales area information, and the customer attribute information, which are stored in the data storage section 142. And the recommendation information acquisition section 102 extracts a classification in which the sales time zone is “10:00-10:59”, the sales area is “Tokyo”, and the customer attribute is “male”. In the case of FIG. 3, classifications to be extracted are the confectionery and the drink in each of which the sales time zone information is “10:00-10:59”, the sales area information is “Tokyo”, and the customer attribute information is “male”. The recommendation information acquisition section 102 acquires the above-described average deviation values of \textcircled{1} and \textcircled{3}, that are the average deviation values of the above-described extracted confectionery and drink, from the average deviation value section 1425.

The recommended commodity determination section 103 determines a recommended commodity based on the recommendation information which the recommendation information acquisition section 102 has acquired. Specifically, in the above-described case (a male accessed the recommend server 1 at 10:30 from Tokyo has purchased a commodity), the recommended commodity determination section 103 determines the drink of the classification the average deviation value of which is the highest as a recommended commodity, based on the information of the above-described average deviation values of \textcircled{1} and \textcircled{3} that are the recommendation information which the recommendation information acquisition section 102 has acquired. In addition, the recommended commodity determination section 103 may comprehensively determine one recommended commodity, in consideration of another option, using the recommendation information which the recommendation information acquisition section 102 has acquired as one option for determining a recommended commodity. More specifically, the recommended commodity determination section 103 may comprehensively determine one recommended commodity, based on the recommendation information which the recommendation information acquisition section 102 has acquired, and other recommendation information. The other recommendation information includes information of a commodity which has been extracted based on purchase history information of a commodity which another person (another customer) has purchased and browsing history information of another person. In addition, the other recommendation information includes information of a commodity extracted based on the feature of the commodity which the customer has purchased, for example. In addition, there are various methods for finally determining the recommended commodity.

The recommended commodity transmission section 104 transmits information of the recommended commodity which has been determined by the recommended commodity determination section 103 to the information terminal 5, via the communication I/F 19.

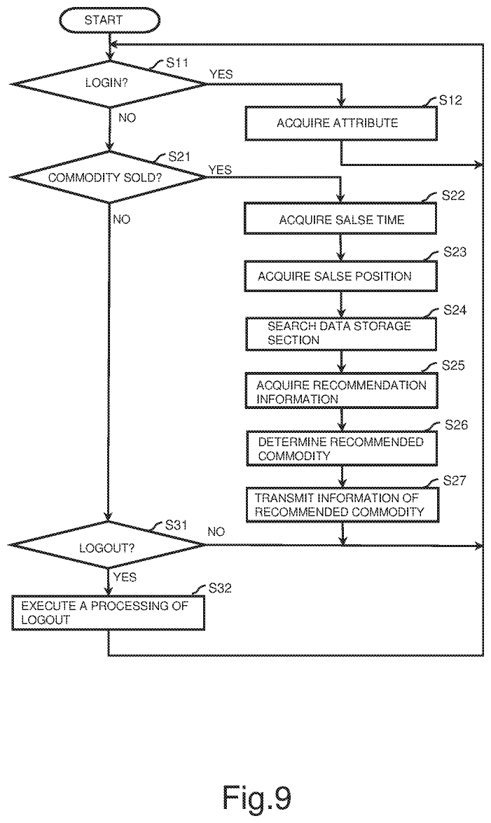

From here on out, control of the recommend server 1 will be described. FIG. 9 is a flow chart showing a control processing of the recommend server 1. As shown in FIG. 9, to begin with in a step S11, the controller 100 of the recommend server 1 judges whether an operation of login has been performed in the information terminal 5 by a customer. When the controller 100 judges that the operation of login has been performed in the information terminal 5 (Yes in step S11), the controller 100 executes a processing of login with respect to the relevant information terminal 5. After the above-described processing of login, in a step S12, the information acquisition section 101 of the controller 100 acquires, from the information terminal 5, attribute information of the customer (male or female?) stored in the information terminal 5, via the communication I/F 19. That is, the information acquisition section 101 acquires the customer attribute information at the time point when the customer has performed the operation of login. And after the acquisition of the above-described customer attribute information, the processing of the controller 100 returns to the step S11.

In addition, when the controller 100 judges that the operation of login has not been performed in the information terminal 5 (No in step S11), the processing of the controller 100 proceeds to a step S21. In the step S21, the controller 100 judges whether an operation of commodity purchase pertaining to the electronic commerce has been performed in the information terminal 5. In other words, the controller 100 judges whether a commodity pertaining to the electronic commerce has been sold by the operation of the information terminal 5. When the controller 100 judges that the commodity has been sold (Yes in step S21), the processing of the controller 100 proceeds to a step S22. In the step S22, the information acquisition section 101 of the controller 100 acquires a current time which the timer 20 has counted as sales time information indicating a sales time when the commodity has been sold. And the information acquisition section 101 recognizes a sales time zone, based on the acquired sales time information. For example, when the above-described acquired sales time information is 10:30, the information acquisition section 101 recognizes 10:00-10:59 including the relevant sales time as the sales time zone, to acquire the sales time zone information. Next, in a step S23, the information acquisition section 101 acquires information of a sales position where the information terminal 5 is located when the commodity has been sold, from the information terminal 5.

The controller 100 acquires sales area information including the acquired sales position information. For example, the controller 100 acquires the sales area information of an area including the acquired sales position information which the GPS information indicates. That is, the controller 100 acquires the sales time zone information and the sales area information of the relevant commodity, at the time point when the customer has purchased the commodity (the time point when the commodity has been sold) by the above-described processings of the steps S21 to S23.

Next, in a step S24, the controller 100 searches the data storage section 142, based on the customer attribute information, the sales time zone information, the sales area information which have been acquired. In a step S25, the recommendation information acquisition section 102 of the controller 100 acquires, from the data storage section 142, recommendation information in which the relevant sale time zone information, the sales area information, and the customer attribute information which have been acquired are all coincident with those informations stored in the data storage section 142, respectively. Specifically, the recommendation information acquisition section 102 extracts all classifications in each of which the sale time zone information, the sales area information, and the customer attribute information which have been acquired are all coincident with those informations stored in the data storage section 142, from the data storage section 142. And the recommendation information acquisition section 102 acquires information of a deviation value (an average deviation value) of the extracted classification, as the recommendation information.

Next, in a step S26, the recommended commodity determination section 103 determines a classification the average deviation value of which is the highest as a recommended commodity, based on the recommendation information which the recommendation information acquisition section 102 has acquired. Next, in a step S27, the recommended commodity transmission section 104 of the controller 100 transmits information of the recommended commodity determined by the recommended commodity determination section 103 to the information terminal 5, via the communication I/F 19. And the processing of the controller 100 returns to the step S11.

In addition, when the controller 100 judges that a commodity pertaining to the electronic commerce has not been sold (No in step S21), the processing of the controller 100 proceeds to a step S31. In the step S31, the controller 100 judges whether an operation of logout has been performed in the information terminal 5. When the controller 100 judges that the operation of logout has been performed in the information terminal 5 (Yes in step S31), the processing of the controller 100 proceeds to a step S32. In the step S32, the controller 100 executes a processing of logout with respect to the relevant information terminal 5. And the processing of the controller 100 returns to the step S11. In addition, when the controller 100 judges that the operation of logout has not been performed in the information terminal 5 (No in step S31), the processing of the controller 100 returns to the step S11.

According to the embodiment like this, the recommend server 1 determines a recommended commodity to a customer, based on the information which has not been used in the conventional electronic commerce, such as the sales time zone information, the sales area information, and the customer attribute information. For the reason, it becomes possible to recommend an exact commodity to a customer.

In addition, according to the embodiment, the recommend server may determine a recommended commodity by comprehensively performing judgment, including the recommendation information acquired by another means. For the reason, it becomes possible to recommend an exact commodity to a customer.

For example, in the embodiment, as the sales time zone, the time zones of “10:00-10:59” and “11:00-11:59” have been described as examples of the sales time zone. However, in the embodiment, without being limited to this, the recommend server 1 may perform the similar processing with respect to another time zone.

Similarly, in the embodiment, the description has been made using Tokyo and Osaka as examples of the sales area. In addition, the description has been made using the confectionery and the drink as examples of the classification. However, in the embodiment, without being limited to this, the recommend server 1 may perform the similar processing with respect to another area, and another classification.

In addition, in the embodiment, the recommend server 1 has been described to have the recommended commodity acquisition section 1a and the information management section 1b. However, in the embodiment, without being limited to this, the recommend server 1 may only have the recommended commodity acquisition section 1a, for example. In this case, another server comes to have the information management section 1b.

In addition, in the embodiment, the recommend server 1 has been described to have the data storage section 142. However, in the embodiment, without being limited to this, a server other than the recommend server 1 may have the data storage section 142.

In addition, in the embodiment, as information indicating a commodity, a classification of an upper concept to tie commodities according to a prescribed rule has been described as an example. However, in the embodiment, without being limited to this, the information indicating a commodity may be commodity specification information to specify the commodity.

In addition, in the embodiment, the recommended commodity determination section 103 may comprehensively determine one recommended commodity, based on the recommendation information which the recommendation information acquisition section 102 has acquired, and the recommendation information acquired by another means. However, in the embodiment, without being limited to this, the recommended commodity determination section 103 may determine the recommended commodity, based on only the recommendation information which the recommendation information acquisition section 102 has acquired, for example.

In addition, the program to be executed by the recommend server 1 of the embodiment is provided while being recorded in a computer readable recording medium, such as a CD-ROM, a flexible disk (FD), a CD-R, a DVD (Digital Versatile Disk), in a file of an installable format or an executable format.

In addition, the program to be executed by the recommend server 1 of the embodiment may be stored on a computer connected to a network such as Internet, and provided by being downloaded through the network. In addition, the program to be executed by the recommend server 1 of the embodiment may be provided or distributed via a network such as Internet.

In addition, the program to be executed by the recommend server 1 of the embodiment may be provided while being previously incorporated in a ROM and so on.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus to manage an electronic commerce site which a customer accesses from an information terminal of the customer to purchase a commodity, comprising:
a communication interface which communicates with the information terminal to perform transmission/reception of information with the information terminal;
a storage device to store sales information of a commodity by sales time zone of the commodity, by sales area of the commodity, and by customer attribute of the commodity, in association with information indicating the commodity; and
a controller which:
acquires information of a sales time indicating the sales time of the commodity, information of a sales position indicating a position of the information terminal at the relevant sales time, and information of a customer attribute indicating an attribute of the customer, from the information terminal, via the communication network,
acquires information for determining a recommended commodity to be recommended to the customer from the storage device, as recommendation information, based on the acquired information of the sales time, the acquired information of the sales position, and the acquired information of the customer attribute,
determines the recommended commodity based on the acquired recommendation information, and
transmits information indicating the determined recommended commodity to the information terminal, via the communication interface.

2. The information processing apparatus according to claim 1, wherein the controller:
acquires information of a sales time zone including the sales time which the information of the sales time indicates,
acquires information of a sales area including the sales position which the information of the sales position information indicates, and
compares the acquired information of the sales time zone, the acquired information of the sales area, and the acquired information of the customer attribute, with the information of the sales time zone, the information of the sales area, and the information of the customer attribute which are stored in the storage device, respectively.

3. The information processing apparatus according to claim 2, wherein the controller acquires the recommendation information from information of a classification indicating the commodity in which the informations of the sales time zone, the informations of the sales area, and the informations of the customer attribute are all coincident, based on the result of the comparison.

4. The information processing apparatus according to claim 1, wherein the controller determines the recommended commodity, based on respective deviation values with respect to variation of the number of sales of commodities pertaining to the information of the sales time, the information of the sales position, and the information of the customer attribute.

5. The information processing apparatus according to claim 2, wherein the controller:
extracts a classification to classify a plurality of commodities from the storage device, based on the information of the sales time zone, the information of the sales area, and the information of the customer attribute, and
acquires a deviation value of the number of sales of the extracted classification as the recommendation information.

6. The information processing apparatus according to claim 5, wherein the controller determines the recommended commodity, based on the deviation value of the number of sales of the extracted classification.

7. The information processing apparatus according to claim 6, wherein the controller determines the classification the deviation value of which is the highest out of the extracted classifications, as the recommended commodity.

8. The information processing apparatus according to claim 4, wherein the controller acquires an average deviation value that is an average value of a deviation value of the number of sales in the sales time zone including the sales time corresponding to the extracted classification, a deviation value of the number of sales in the sales area including the sales position corresponding to the extracted classification, and a deviation value of the number of sales by persons with the sales attribute corresponding to the extracted classification, as the recommendation information.

9. The information processing apparatus according to claim 5, wherein the controller comprehensively judges information including at least the acquired recommendation information to determine the recommended commodity.

10. An information processing method of an information processing apparatus to manage an electronic commerce site which a customer accesses from an information terminal of the customer to purchase a commodity, comprising:
storing sales information of a commodity by sales time zone of the commodity, by sales area of the commodity, and by customer attribute of the commodity, in association with information indicating the commodity, in a storage device;
acquiring information of a sales time indicating the sales time of the commodity, information of a sales position indicating a position of the information terminal at the relevant sales time, and information of a customer attribute indicating an attribute of the customer, from the information terminal, via the communication network;
acquiring information for determining a recommended commodity to be recommended to the customer from the storage device, as recommendation information, based on the acquired information of the sales time, the acquired information of the sales position, and the acquired information of the customer attribute;
determining the recommended commodity based on the recommendation information; and
transmitting information indicating the determined recommended commodity to the information terminal, via the communication interface.
